(19) United States
(12) Patent Application Publication
(10) Pub. No.: US 2023/0022059 A1
(43) Pub. Date: Jan. 26, 2023

(54) ELECTRIFIED DRIVE TRAIN HAVING A HEAT EXCHANGER ARRANGEMENT

(71) Applicant: Schaeffler Technologies AG & Co. KG, Herzogenaurach (DE)

(72) Inventors: Marco Grethel, Bühlertal (DE); Götz Rathke, Hohberg (DE)

(73) Assignee: Schaeffler Technologies AG & Co. KG, Herzogenaurach (DE)

(21) Appl. No.: 17/784,171

(22) PCT Filed: Dec. 3, 2020
(86) PCT No.: PCT/DE2020/101020

§ 371 Date: Jun. 10, 2022

(30) Foreign Application Priority Data
Dec. 18, 2019 (DE) 10 2019 134 941.9
Feb. 5, 2020 (DE) 10 2020 102 884.9

(51) Int. Cl. B60K 11/02; B60K 1/02; B60K 1/00

(52) U.S. Cl. CPC B60K 11/02; B60K 1/02; B60K 1/00; B60K 2001/006

(57) ABSTRACT

An electrified drive train for a motor vehicle, having a heat generator, includes at least one electrical drive machine, and a heat dissipation circuit which has at least one first heat exchanger and one second heat exchanger for dissipating heat from a cooling circuit which is routed through the heat generator. During operation, a fluid used in the heat dissipation circuit flows through the first heat exchanger and, parallel thereto, through the second heat exchanger.

### CROSS-REFERENCE TO RELATED APPLICATIONS

This application is the U.S. National Phase of PCT Appln. No. PCT/DE2020/101020 filed Dec. 3, 2020, which claims priority to DE 10 2019 134 941.9 filed Dec. 18, 2019 and DE 10 2020 102 884.9 filed Feb. 5, 2020, the entire disclosures of which are incorporated by reference herein.

### TECHNICAL FIELD

The disclosure relates to an electrified drive train for a motor vehicle, having a heat generator, having at least one electrical drive machine, and a heat dissipation circuit, which has at least one first heat exchanger and one second heat exchanger for dissipating heat from a cooling circuit which is routed through the heat generator. The disclosure further relates to an electric vehicle having such an electrified drive train.

### BACKGROUND

Electrified drive trains are already known from the prior art, which are driven purely electrically instead of by an internal combustion engine. However, the prior art always has the disadvantage that, in particular in the case of electric vehicles, the range can be adversely affected by the power required for a consumer, such as a (cooling) fluid pump.

### SUMMARY

It is therefore the object of the disclosure to avoid or at least to mitigate the disadvantages of the prior art. In particular, an electrified drive train and an electric vehicle are to be provided in which a high achievable cooling capacity can be achieved with a low pump capacity required by means of a heat dissipation circuit, in order to increase the range of the electric vehicle.

This object is achieved in a generic device according to the disclosure in that, during operation, a fluid used in the heat dissipation circuit, in particular in the cooling water circuit, preferably water, flows through the first heat exchanger and parallel thereto through the second heat exchanger. In other words, at least partial parallelization of the flow through the heat dissipation circuit is proposed according to the disclosure.

This has the advantage that in particular the problems that arise when multiple heat exchangers are to be flooded with cooling fluid/cooling water, such as a summation of the flow resistances and a sequence of the heat exchangers, can be solved. For example, with two electric drives, two power electronics and two electric motors have to be cooled, so that four heat exchangers would have to be flooded. If these heat exchangers were arranged sequentially, the order of water heating, the residual cooling capacity for the subsequent heat exchanger and the summation of the flow resistances would have to be taken into account. As a rule, with such a sequential arrangement, the load pressure for the pump is too high. Due to the partially parallel flow according to the disclosure, the load pressure for providing the cooling water flow can be kept low, so that the power (Q*p) required for the pump is also lower and the range of the electric vehicle is less adversely affected. Accordingly, according to the disclosure, an advantageous design with regard to the flow resistance of the fluid/water through the heat exchanger, an interaction with the flow rate and the achievable cooling capacity is proposed.

Advantageous embodiments are claimed and are explained below.

According to a preferred embodiment, a volume flow of the heat dissipation circuit can be divided at a node into a first partial volume flow, which is routed through the first heat exchanger, and a second partial volume flow, which is routed through the second heat exchanger. Alternatively, it is also possible to split the volume flow of the heat dissipation circuit several times, i.e., to distribute it over more than two partial volume flows.

In an advantageous embodiment, the heat dissipation circuit can have a hydraulic resistance, by means of which the distribution of the volume flow to the first partial volume flow and the second partial volume flow can be adjusted. In other words, it is proposed to provide an adjustable hydraulic resistance in the direction of flow in the node or downstream of the node of the parallelization. As a result, an undesired division of the volume flow and thus of the cooling capacity can be avoided. Such an undesirable division results from the fact that individual heat exchangers have different flow resistances; for example, due to tolerances.

According to the advantageous embodiment, the hydraulic resistance can be designed as a passive control element/passive valve arrangement. As a result, a necessary division of the volume flow can be implemented when the section/water section is put into operation. A passive control element is understood to mean that the control element carries out a control action, such as limiting the flow rate, from the available hydraulic control variables, such as a flow rate. Such a hydraulic manipulated variable can also be tapped off from the cooling circuit routed through the heat generator and fed to the control element via corresponding hydraulic active surfaces.

According to the advantageous embodiment, the hydraulic resistance can be designed as an active control element/an active valve arrangement. By providing an active control element, the volume flow can be adjusted as desired. Preferably, the volume flow can be adjusted by the active control element as a function of an operating state of the (electric) vehicle and/or an operating state of the electrical drive machine. In this way, the volume flow can be divided asymmetrically, for example temporarily, as a result of the parallelization. Cooling efficiency can be increased through need-based control. An active control element is understood to mean that the control element can be controlled by an electrical control element, such as an electromagnet or an electric motor.

In addition, it is preferred if the (active or passive) control element is designed as a seat, sieve or rotary slide valve. This allows a relatively simple and inexpensive control element to be installed.

In a preferred embodiment, the drive train can have two electrical drive machines, each having power electronics and an electric motor, wherein a heat exchanger for the two power electronics, i.e., for the cooling circuit routed through the power electronics, is arranged upstream of the node in the common volume flow.

In another preferred embodiment, the drive train can have two electrical drive machines, each having power electronics and an electric motor, wherein a heat exchanger for one power electronics, i.e., for the cooling circuit routed through the one power electronics, is arranged downstream of the node in the first partial volume flow and a heat exchanger for the other power electronics, i.e., for the cooling circuit routed through the other power electronics, is arranged downstream of the node in the second partial volume flow.

According to the preferred embodiment, the heat exchangers for the power electronics, i.e., for the cooling circuit(s) routed through the power electronics, can be arranged upstream of the heat exchangers for the electric motors, i.e., for the cooling circuits routed through the electric motor.

The object of the disclosure is also achieved by an electric vehicle having an electrified drive train according to the disclosure.

According to a second aspect independent of the first aspect of the disclosure, the disclosure also relates to an electrified drive train for a motor vehicle, having a heat generator, comprising at least one electrical drive machine, and a cooling circuit routed by the electrical drive machine, which has a heat exchanger for dissipating heat from the cooling circuit, wherein the heat exchanger is arranged in the cooling circuit, in particular in the cooling oil circuit, in the flow direction of the fluid used in the cooling circuit, preferably oil, downstream of the heat generator to be cooled. This has the advantage that the waste heat from the heat generator to be cooled can be used by making the heat given off to a heat dissipation circuit, usually a water circuit, available to the vehicle. By arranging the heat exchanger downstream of the heat generator to be cooled, a greater proportion of the heat can be used as waste heat compared to the case when the heat exchanger is arranged upstream of the heat generator to be cooled in order to maximize the cooling capacity. Existing heat sources are therefore used for the heating function. This can overcome the disadvantage that, in particular in such purely electrically driven vehicles, the internal combustion engine is missing as a heat source and electric auxiliary heaters have to be used in order to be able to implement a comfort function, such as heating, in the passenger compartment. An electrified drive train is thus provided in which, if possible, no additional heaters are required, but other heat sources are used.

According to a preferred embodiment, the heat exchanger can be arranged directly downstream of the heat generator to be cooled. This advantageously ensures that the waste heat from the drive train is made available to the vehicle as completely as possible. By arranging the heat exchanger directly downstream of the heat generator, heat loss through convection can be prevented or at least minimized.

In addition, it is advantageous if the heat generator is the electrical drive machine or a secondary unit, such as power electronics and/or a clutch and/or a transmission. The electric drive machine in particular makes a large part of the waste heat available. The power electronics is also a large heat generator.

Furthermore, it is expedient if the drive train has multiple heat generators to be cooled, wherein the heat exchanger is arranged downstream of the heat generator to be cooled with the greatest heat generation. It can thus be ensured that as much waste heat as possible is made available for the comfort functions such as a heating function of the vehicle.

Furthermore, according to an advantageous development, the heat exchanger can be arranged, preferably directly upstream of the heat generators to be cooled, away from the heat generator with the greatest heat generation. This has the advantage that the cooling capacity is optimally utilized.

In addition, it is expedient if a volume flow of the cooling circuit is divided into partial volume flows that run parallel to one another. This means that the volume flow of the cooling circuit is at least partially parallelized. A node of the cooling circuit, at which the volume flow is divided into the partial volume flows, is preferably located directly downstream of the heat exchanger.

According to a preferred development, the volume flow can have a first partial volume flow for cooling the transmission. Alternatively or additionally, the volume flow can have a second partial volume flow for cooling the clutch.

Furthermore, it is expedient if the cooling circuit has a hydraulic resistance arranged in the volume flow for adjusting the flow of the partial volume flows. The throughflow of the partial volume flows can thus be adapted to the heat generator to be cooled, which is arranged in the respective partial volume flow. In this way, the cooling fluid can be supplied as required.

The hydraulic resistance can preferably be formed as an active control element, i.e., as a control element controlled by an electric control element, such as an electric magnet or an electric motor, or as a passive control element, i.e., as a (fixed) set from the existing hydraulic control variables control element.

According to an advantageous embodiment, the drive train can have the cooling circuit routed through the electrical drive machine and a second cooling circuit routed through the power electronics, wherein the heat exchanger of the cooling circuit is arranged downstream of the electrical drive machine and a heat exchanger of the second cooling circuit is arranged downstream of the power electronics.

According to a third aspect of the disclosure, the first aspect of the disclosure and the second aspect of the disclosure can also be combined. The disclosure also relates to an electrified drive train for a motor vehicle having a cooling circuit/cooling oil circuit designed according to the disclosure and a heat dissipation circuit/cooling water circuit designed according to the disclosure.

In other words, the disclosure relates to a specific heat exchanger arrangement in the water cooling circuit and/or in the oil cooling circuit in vehicles with electric motors. In particular, the disclosure thus relates to a drive train having at least one electric drive. Similar to a drive train having an internal combustion engine, a loss of the drive machine should be effectively dissipated to protect components and used sensibly, for example, to increase the efficiency of the vehicle. According to the disclosure, the cooling water circuit/heat dissipation circuit and the cooling oil circuit/cooling circuit are improved in particular in the case of a drive train having multiple electrical drive machines.

In previous cooling (oil) circuits, a heat exchanger was typically arranged upstream of the object/heat generator to be cooled, so that the cooling fluid, such as oil, is as cool as possible and the cooling capacity is therefore as high as possible. However, since (purely) electrically powered vehicles in particular lack an important source of heat from the combustion engine, electric auxiliary heaters must be used; for example, to increase the comfort of the passenger compartment and to heat it. According to the disclosure, the heat exchanger is arranged in the cooling circuit in such a way that the waste heat from the drive function can be used at least partially as a heat source or for the heating function. Accordingly, the heat exchanger(s) is arranged downstream of the object/heat generator to be cooled in order to transfer as much heat as possible into a heat dissipation circuit. This heat can then be used for the vehicle's heating functions. In other words, the heat exchanger/cooler is arranged (directly) downstream of the main heat generator in order to prevent convection and to be able to supply the vehicle with the waste heat from the drive train as completely as possible.

The heat dissipation circuit/cooling (water) circuit according to the disclosure involves the flow resistance of the water through the heat exchanger and the interaction with the flow rate and thus the achievable cooling capacity. In order to keep the load pressure for providing the cooling water flow and thus the required power as low as possible, it is problematic to sequentially flow cooling water through multiple heat exchangers—in the case of two e-drives, four heat exchangers for two power electronics and two e-motors—because the order of the heat exchangers and the summation of the flow resistances must be observed. According to the disclosure, at least a partial parallelization of the flow is proposed. Due to tolerances, however, different flow resistances can result, which can lead to an undesirable distribution of the cooling capacity. For this reason, an adjustable hydraulic resistance is provided in the direction of flow downstream of the node of the parallelization, which can be active, i.e., continuously controllable, or passive, i.e., initially adjustable.

### BRIEF DESCRIPTION OF THE DRAWINGS

The disclosure is explained below with the aid of drawings. In the figures:

FIG. 1 shows a schematic representation of a part of a cooling circuit according to the disclosure in a first embodiment,

FIG. 2 shows a schematic representation of another part of the cooling circuit according to the disclosure,

FIG. 3 shows a schematic representation of a heat dissipation circuit according to the disclosure in a first embodiment,

FIG. 4 shows a schematic representation of a heat dissipation circuit according to the disclosure in a second embodiment

FIG. 5 shows a schematic representation of a heat dissipation circuit according to the disclosure in a third embodiment,

FIG. 6 shows a schematic representation of an exemplary heat dissipation circuit, and

FIG. 7 shows an exemplary basic configuration of a cooling system having a cooling circuit and a heat dissipation circuit.

### DETAILED DESCRIPTION

The figures are only schematic in nature and serve only for understanding the disclosure. The same elements are provided with the same reference symbols. The features of the individual embodiments can be interchanged.

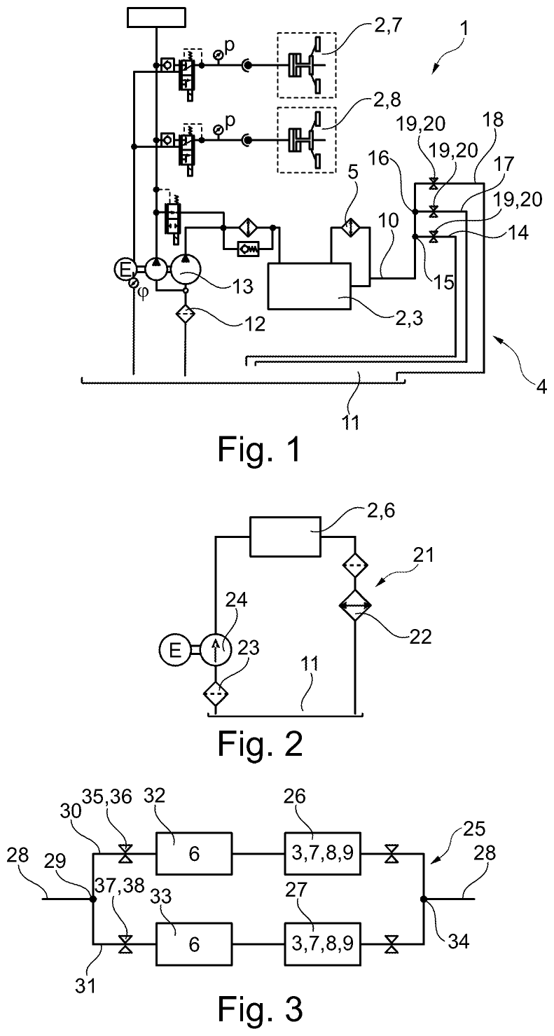

FIG. 1 schematically shows a first part of a drive train 1 according to the disclosure for a motor vehicle, in particular an electric vehicle. The drive train 1 is electrified. The drive train 1 has a heat generator 2. The heat generator 2 comprises at least one electrical drive machine 3. The drive train 1 has a cooling circuit 4 that runs through the electrical drive machine 3. The cooling circuit 4 has a heat exchanger 5 for dissipating heat from the cooling circuit 4.

According to the disclosure, the heat exchanger 5 in the cooling circuit 4 is arranged downstream of the heat generator 2 to be cooled in the direction of flow of the fluid used in the cooling circuit 4, in particular oil. In the cooling circuit 4 shown in FIG. 1, the heat exchanger 5 is arranged downstream of the electrical drive machine 3. As a result, a large part of the heat generated by the electrical drive machine 3 can be used as waste heat for heating a passenger compartment.

The drive train 1 also has one or more secondary units. A secondary unit can be power electronics 6 (see FIG. 2), for example. A secondary unit can be a first clutch 7 or a second clutch 8, for example. A secondary unit can also be a transmission 9, for example. The drive train 1 therefore generally has multiple heat generators 2 to be cooled. According to the disclosure, the heat exchanger 5 is arranged in particular downstream of the heat generator 2 to be cooled with the greatest heat generation, such as the drive machine 3. In addition, the heat exchanger 5 can be arranged in front of, in particular directly in front of, the heat generators 2 to be cooled, apart from the heat generator 2 with the greatest heat generation, i.e., the drive machine 3 here. As a result, sufficient cooling energy can be made available to the other heat generators 2.

In the illustrated embodiment, a volume flow 10 of the cooling circuit 4 is divided into partial volume flows that run parallel to one another. The oil is thus sucked in from an oil sump 11, preferably via a suction filter 12, by a cooling pump 13. Then the oil of the volume flow 10 is conveyed through the drive machine 3 by the cooling oil pump 13. In the direction of flow downstream, the heat exchanger 5 is flooded. The volume flow 10 is divided downstream. A first partial volume flow 14 branches off from the volume flow 10 at a first node 15, which has a lower flow rate than the volume flow 10. Downstream, the volume flow is divided at a second node 16 into a second partial volume flow 17 and a third partial volume flow 18. The first partial volume flow 17 can be designed for cooling the first clutch 7 and/or the second clutch 8, for example. The first partial volume flow 17 can be designed for cooling the transmission 9, for example. Preferably, the throughflow of the first partial volume flow 14 and the throughflow of the second partial volume flow 17 and the third partial volume flow 18 together are essentially the same magnitude.

In the volume flow 10, a hydraulic resistance 19 is arranged to adjust the flow of the partial volume flows. In the embodiment shown, a hydraulic resistance 19 is arranged in each of the three partial volume flows 14, 17, 18. In the embodiment shown, the hydraulic resistance 19 is designed as a passive control element 20. The hydraulic resistance 19 can also be designed as an active control element, even if this is not shown in FIG. 1.

According to the disclosure, the drive train 1 thus has the cooling circuit 4 which runs through the electrical drive machine 3 and in which the heat exchanger 5 of the cooling circuit 4 is arranged downstream of the electrical drive machine 3.

FIG. 2 shows another part of the drive train 2. FIG. 2 shows a second cooling circuit 21 routed by the power electronics 6. A heat exchanger 22 of the second cooling circuit 21 is arranged downstream of, preferably directly downstream of, the power electronics 6 in the flow direction of the cooling fluid. As a result, the waste heat from the power electronics can be used. In the second cooling circuit 21, the oil is sucked in from the oil sump 11, preferably via a suction filter 23, by a cooling pump 24. The oil is then conveyed through the power electronics 6 by the cooling oil pump 24. In the direction of flow downstream, the heat exchanger 22 is flooded.

FIGS. 3 to 6 show schematic representations of a heat dissipation circuit 25 of the drive train 1 according to the disclosure. In particular in FIGS. 3 to 5, the structure of the heat dissipation circuit 25 according to an aspect of the disclosure with regard to a heat exchanger arrangement is illustrated.

The drive train 1 has the heat generator 2 comprising the at least one electrical drive machine 3. In order to be able to dissipate the heat from a cooling circuit routed through the heat generator 2, the drive train 1 has the heat dissipation circuit 25. The heat dissipation circuit 25 has at least a first heat exchanger 26 and a second heat exchanger 27 for dissipating heat from the cooling circuit. The cooling circuit can, for example, be formed by the first cooling circuit 4 and the second cooling circuit 21 shown in FIGS. 1 and 2. However, the cooling circuit can also be designed differently. An exemplary configuration of a cooling system having a cooling circuit and a heat dissipation cycle will be explained with reference to FIG. 7.

According to the disclosure, the heat dissipation circuit 25 is designed such that during operation a fluid used in the heat dissipation circuit 25, such as water, flows through the first heat exchanger 26 and parallel thereto through the second heat exchanger 27. This means that a volume flow 28 of the heat dissipation circuit 25 is at least partially parallelized, i.e., divided into at least two partial volume flows. The volume flow 28 is divided into a first partial volume flow 30 and a second partial volume flow 31 at a node 29. At least one heat exchanger is arranged in each of the partial volume flows 30, 31, so that the heat exchangers are flooded in parallel.

In the embodiment shown in FIGS. 3 to 5, the drive train 1 has two electrical drive machines 3. In addition, the drive train 1 has the power electronics 6, the first clutch 7 and/or the second clutch 8 and the transmission 9 for each drive machine 3.

In the embodiment shown in FIG. 3, the drive train 1 has two heat exchangers for cooling the components of each drive machine 3. A heat exchanger for cooling the power electronics 6 and a heat exchanger for cooling the drive machine 3, the first clutch 7, the second clutch 8 and/or the transmission 9 are designed for each drive machine 3. The first heat exchanger 26 for cooling the (first) drive machine 3 (with the first clutch 7, the second clutch 8 and/or the transmission 9) is arranged in the first partial volume flow 30. The second heat exchanger 27 for cooling the (second) drive machine 3 (with the first clutch 7, the second clutch 8 and/or the transmission 9) is arranged in the second partial volume flow 31. A third heat exchanger 32 for cooling the (first) power electronics 6 is arranged in the first partial volume flow 30. A fourth heat exchanger 33 for cooling the (second) power electronics 6 is arranged in the second partial volume flow 31. The first partial volume flow 30 and the second partial volume flow 31 combine at a second node 34 to form the common volume flow 28. A first hydraulic resistance 35 is arranged in the first partial volume flow 30. The first hydraulic resistance 35 is designed as a passive control element 36. A second hydraulic resistance 37 is arranged in the second partial volume flow 31. The second hydraulic resistance 37 is designed as a passive control element 38. The distribution of the volume flow 28 to the partial volume flows 30, 31 can be set initially by the passive control elements 36, 38.

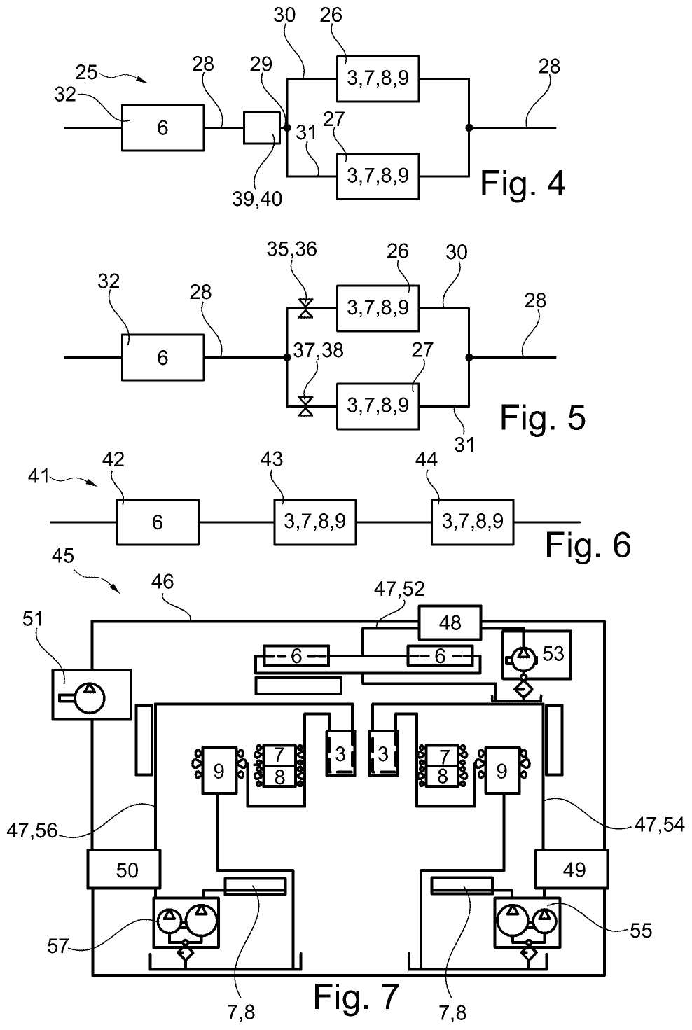

In the embodiment shown in FIG. 4, the drive train 1 has a heat exchanger for cooling the (first and second) electronic power units 6 and a heat exchanger for cooling the two drive machines 3. The first heat exchanger 26 for cooling the (first) drive machine 3 (with the first clutch 7, the second clutch 8 and/or the transmission 9) is arranged in the first partial volume flow 30. The second heat exchanger 27 for cooling the (second) drive machine 3 (with the first clutch 7, the second clutch 8 and/or the transmission 9) is arranged in the second partial volume flow 31. The third heat exchanger 32 for cooling the (first and second) electronic power units 6 is arranged in the volume flow 28. The first partial volume flow 30 and the second partial volume flow 31 combine at the second node 34 to form the common volume flow 28. A hydraulic resistance 39 is arranged at the node 29. The hydraulic resistance 39 is designed as an active control element 40. The distribution of the volume flow 28 to the partial volume flows 30, 31 can be regulated continuously by the active control element 40.

In the embodiment shown in FIG. 5, the drive train 1 has a heat exchanger for cooling the (first and second) electronic power units 6 and a heat exchanger for cooling the two drive machines 3. The first heat exchanger 26 for cooling the (first) drive machine 3 is arranged in the first partial volume flow 30. The second heat exchanger 27 for cooling the (second) drive machine 3 is arranged in the second partial volume flow 31. The third heat exchanger 32 for cooling the (first and second) electronic power units 6 is arranged in the volume flow 28. The first hydraulic resistance 35 embodied as the passive control element 36 is arranged in the first partial volume flow 30. The second hydraulic resistance 37 embodied as the passive control element 38 is arranged in the second partial volume flow 31. The distribution of the volume flow 28 to the partial volume flows 30, 31 can be set initially by the passive control elements 36, 38.

The embodiment shown in FIG. 6 shows a heat dissipation circuit 41, in which a heat exchanger 42 for the (first and second) power electronics 6, a heat exchanger 43 for cooling the (first) drive machine 3 (with the first clutch 7, the second clutch 8 and/or the transmission 9) and a heat exchanger 44 for cooling the (second) engine 3 (with the first clutch 7, the second clutch 8 and/or the transmission 9) are arranged sequentially, one downstream of the other.

FIG. 7 shows an exemplary basic structure of a cooling system 45. The cooling system 45 has a heat dissipation circuit/water cooling circuit 46 and multiple cooling circuits/cooling oil circuits 47. The structure of the heat dissipation circuit 46 corresponds to that of the heat dissipation circuit 41 shown in FIG. 6, in which a first heat exchanger 48, a second heat exchanger 49 and a third heat exchanger 50 are arranged in series one downstream of the other. A cooling pump 51 pumps the fluid, here water, through the heat dissipation circuit 46.

The first heat exchanger 48 exchanges heat with a first cooling circuit 52. In the first cooling circuit 52, fluid, here oil, is conveyed by a cooling pump 53 to the first power electronics 6 and to the second power electronics 6. The second heat exchanger 49 exchanges heat with a second cooling circuit 54. In the second cooling circuit 54, fluid, here oil, is conveyed by a cooling pump 55 to the first drive machine 3, the first clutch 7 and the second clutch 8 of a double clutch and the transmission 9. The third heat exchanger 50 exchanges heat with a third cooling circuit 56. In the third cooling circuit 56, fluid, here oil, is conveyed by a cooling pump 57 to the second drive machine 3, the first clutch 7 and the second clutch 8 of a double clutch and the transmission 9.

### LIST OF REFERENCE SYMBOLS

1 Drive train
2 Heat generator
3 Drive machine
4 Cooling circuit
5 Heat exchanger
6 Power electronics
7 First clutch
8 Second clutch
9 Transmission
10 Volume flow
11 Oil sump
12 Suction filter
13 Cooling oil pump
14 First partial flow
15 First node
16 Second node
17 Second partial flow
18 Third partial flow
19 Hydraulic resistance
20 Passive control element
21 Second cooling circuit
22 Heat exchanger
23 Suction filter
24 Cooling oil pump
25 Heat dissipation circuit
26 First heat exchanger
27 Second heat exchanger
28 Volume flow
29 Node
30 First partial flow
31 Second partial flow
32 Third heat exchanger
33 Fourth heat exchanger
34 Second node
35 Hydraulic resistance
36 Passive control element
37 Hydraulic resistance
38 Passive control element
39 Hydraulic resistance
40 Active control element
41 Heat dissipation circuit
42 First heat exchanger
43 Second heat exchanger
44 Third heat exchanger
45 Cooling system
46 Heat dissipation circuit
47 Cooling circuit
48 First heat exchanger
49 Second heat exchanger
50 Third heat exchanger
51 Cooling pump
52 First cooling circuit
53 Cooling pump
54 Second cooling circuit
55 Cooling pump
56 Third cooling circuit
57 Cooling pump

1. An electrified drive train for a motor vehicle, comprising: a heat generator, comprising at least one electrical drive machine, and a heat dissipation circuit which has at least one first heat exchanger and one second heat exchanger for dissipating heat from a cooling circuit which is routed through the heat generator, wherein, during operation, a fluid used in the heat dissipation circuit flows through the first heat exchanger and, parallel thereto, through the second heat exchanger.

2. The electrified drive train according to claim 1, wherein a volume flow of the heat dissipation circuit is divided at a node into a first partial volume flow, which is routed through the first heat exchanger, and into a second partial volume flow, which is routed through the second heat exchanger.

3. The electrified drive train according to claim 2, wherein the heat dissipation circuit has a hydraulic resistance by which a distribution of the volume flow to the first partial volume flow and the second partial volume flow can be adjusted.

4. The electrified drive train according to claim 3, wherein the hydraulic resistance is designed as a passive control element.

5. The electrified drive train according to claim 3, wherein the hydraulic resistance is designed as an active control element.

6. The electrified drive train according to claim 4, wherein the control element is designed as a seat, sieve or rotary slide valve.

7. The electrified drive train according to claim 2, further comprising, two electrical drive machines, each having a power electronics and an electric motor, wherein a heat exchanger for the power electronics is arranged upstream of the node in the volume flow.

8. The electrified drive train according to claim 2, further comprising: two electrical drive machines, each having a power electronics and an electric motor, wherein a heat exchanger for one power electronics is arranged after the node in the first partial volume flow and a heat exchanger for the other power electronics is arranged after the node in the second partial volume flow.

9. The electrified drive train according to claim 7, wherein the heat exchanger for the power electronics is arranged upstream of the heat exchanger for the electric motor in the flow direction of the fluid.

10. An electric vehicle comprising: an electrified drive train having a heat generator, comprising at least one electrical drive machine, and a heat dissipation circuit which has at least one first heat exchanger and one second heat exchanger for dissipating heat from a cooling circuit which is routed through the heat generator, wherein, during operation, a fluid used in the heat dissipation circuit flows through the first heat exchanger and, parallel thereto, through the second heat exchanger.

11. An electrified drive train for a motor vehicle, comprising:
a heat generator, comprising two electrical drive machines each having a power electronics and an electric motor; and
a heat dissipation circuit having a first heat exchanger and a second heat exchanger arranged in parallel with each other and configured for dissipating heat from a cooling circuit which is routed through the heat generator, wherein a volume flow of the heat dissipation circuit is divided at a node into a first partial volume flow routed through the first heat exchanger, and into a second partial volume flow routed through the second heat exchanger.

12. The electrified drive train according to claim 11, wherein a heat exchanger for the power electronics of the two electrical drive machines is arranged upstream of the node in the volume flow.

13. The electrified drive train according to claim 12, wherein the heat exchanger for the power electronics is arranged upstream of a heat exchanger for the electric motor in the flow direction of fluid.

14. The electrified drive train according to claim 11, wherein a heat exchanger for one power electronics is arranged after the node in the first partial volume flow and a heat exchanger for the other power electronics is arranged after the node in the second partial volume flow.
